(19) United States
(12) Patent Application Publication
(10) Pub. No.: US 2010/0192090 A1
(43) Pub. Date: Jul. 29, 2010

(54) ORDER RECEIVING APPARATUS AND ORDER RECEIVING METHOD

(75) Inventors: Kenya Hiramatsu, Tokyo (JP); Yumiko Okuma, Tokyo (JP); Hisashi Sato, Shizuoka (JP); Masanori Sambe, Shizuoka (JP); Takashi Makiyama, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/692,883

(22) Filed: Jan. 25, 2010

(30) Foreign Application Priority Data
Jan. 26, 2009 (JP) 2009-014692
Aug. 4, 2009 (JP) 2009-181725

(51) Int. Cl. G06F 3/048

(52) U.S. Cl. 715/798

(57) ABSTRACT

An order receiving apparatus includes: a display control unit configured to display an order input screen in which function information concerning menu order functions is arranged in a plurality of areas; a moving unit configured to move a boundary between the areas adjacent to each other; and a scaling unit configured to scale the function information arranged in the areas adjacent to each other across the moved boundary.

### CROSS-REFERENCE TO RELATED APPLICATION

This application claims the benefit of priority from Japanese Patent Application No. 2009-014692 filed on Jan. 26, 2009 and Japanese Patent Application No. 2009-181725 filed on Aug. 4, 2009, the entire content of which is incorporated herein by reference.

### TECHNICAL FIELD

The present invention relates to an order receiving apparatus set in an eating house such as a restaurant and used for inputting customer guide information, menu order information, and the like to support customer service jobs and an order receiving method for the order receiving apparatus.

### BACKGROUND

In many eating houses such as a family restaurant and a bar, an order management system that can centrally manage jobs ranging from food and drink menu order to checkout is installed (see JP-A-2008-299821). The system disclosed in JP-A-2008-299821 includes a checkout apparatus such as an electronic cash register or a point of sales (POS) terminal set in a register serving as a checkout place for payment, a station configured to execute, for example, management of various kinds of information transmitted from the checkout apparatus, a slip issuance printer connected to the checkout apparatus and configured to print and issue an order slip, and a kitchen printer configured to print and output a cooking instruction slip. In the system disclosed in JP-A-2008-299821, the station, the slip issue printer, the kitchen printer, and the checkout apparatus are connected via a communication line such as a local area network (LAN).

However, in the checkout apparatus disclosed in JP-A-2008-299821, since a layout of menu item buttons, an order list, and the like on an order screen is determined in advance, a user cannot freely change the layout to a layout that the user desires to use. Therefore, convenience of the checkout apparatus is low.

### SUMMARY

According to an aspect of the present invention, there is provided an order receiving apparatus including: a display control unit configured to display an order input screen in which function information concerning menu order functions is arranged in a plurality of areas; a moving unit configured to move a boundary between the areas adjacent to each other; and a scaling unit configured to scale the function information arranged in the areas adjacent to each other across the moved boundary.

According to another aspect of the present invention, there is provided an order receiving method including: displaying an order input screen in which function information concerning menu order functions is arranged in a plurality of areas; moving a boundary between the areas adjacent to each other; and scaling the function information arranged in the areas adjacent to each other across the moved boundary.

### DESCRIPTION OF THE DRAWINGS

FIG. 1 is a schematic system diagram of the overall configuration of a customer-service supporting system;

FIG. 2 is a block diagram of electric connection of an information terminal;

FIG. 3 is a block diagram of electric connection of a station;

FIG. 4 is a schematic diagram of the file structure of a section file accessible by the information terminal and the station;

FIG. 5 is a schematic diagram of the file structure of a price look up (PLU) file accessible by the information terminal and the station;

FIG. 6 is a block diagram of the functional configuration of the information terminal;

FIG. 7 is an illustrative front view of an order input screen;

FIG. 8 is an illustrative front view of the order input screen including a slide bar displayed as a special image;

FIG. 9 is a flowchart for explaining a flow of layout change processing; and

FIG. 10 is an illustrative diagram of the order input screen.

### DETAILED DESCRIPTION

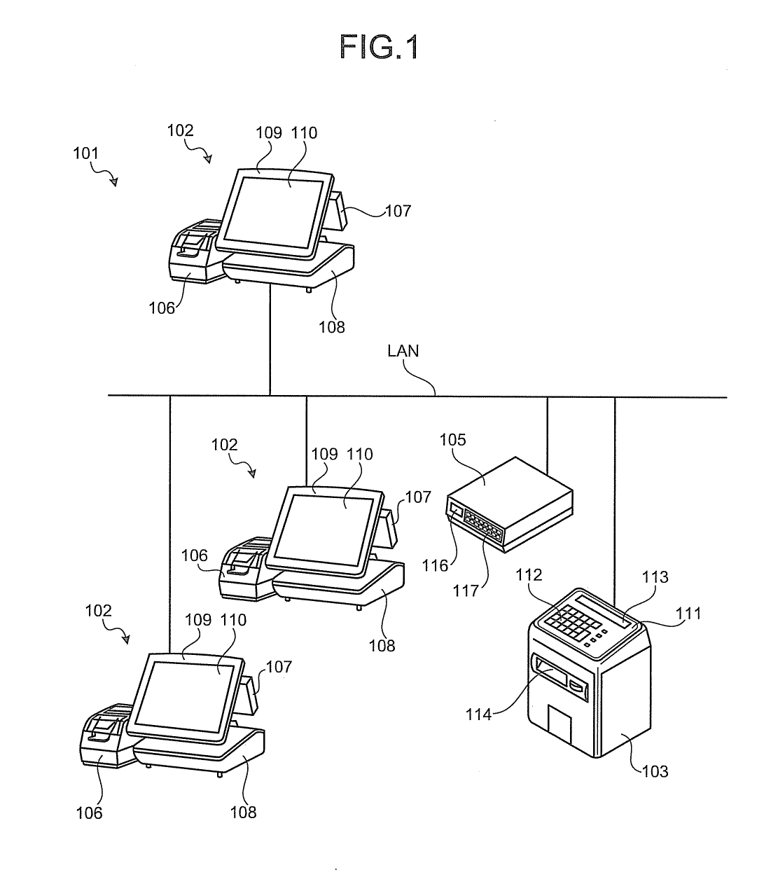

An embodiment of the present invention is explained below with reference to FIGS. 1 to 10. This embodiment is an example of an information terminal of a customer-service supporting system configured to receive an order and support customer-service jobs such as a table service (table setting) in an overall flow of customer service for guiding a visiting customer to a table arranged in a service floor, receiving an order, and performing a table service (table setting). In this embodiment, the information terminal is applied as an order receiving apparatus.

FIG. 1 is a schematic system diagram of the overall configuration of the customer-service supporting system. A customer-service supporting system 101 shown in FIG. 1 includes information terminals 102 set in a service floor and a checkout counter, a kitchen printer 103 set in a kitchen, and a station 105 as a server configured to control the entire customer-service supporting system 101 set in a backyard or the like of a store.

Basic structure and functions of the information terminals 102 are the same irrespectively of whether the information terminals 102 are set in the service floor or set in the checkout counter. An only difference is a form of use of the information terminals 102. Specifically, the information terminals 102 set in the service floor support jobs such as a customer guide job, an order receiving job, and a table service (table setting) job. On the other hand, the information terminal 102 set in the checkout counter supports a checkout job in addition to the jobs such as the customer guide job, the order receiving job, and the table service (table setting) job. In other words, the information terminal 102 set in the checkout counter also functions as a so-called POS terminal. Because of the difference in the jobs supported by the information terminals 102, whereas printers 106 for issuance of receipts and slips are connected to both the information terminals 102 set in the service floor and the checkout counter, a customer-side display device 107 is also connected to the information terminal 102 set in the checkout counter in addition to the printer 106.

In each of the information terminals 102, a liquid crystal display 109 as a display device is placed on the upper surface of a main body unit 108. Further, in the information terminal 102, a touch panel 110 as an input device is laminated and arranged on a display surface of the liquid crystal display 109. The printer 106 is set near and adjacent to the information terminal 102 and connected to the information terminal 102 via an interface such as a universal serial bus (USB).

In the information terminal 102, as an example, the customer-side display device 107 as an LED display device configured to display seven segments is placed on the upper surface of the main body unit 108. Like the printer 106, the customer-side display device 107 is also connected to the information terminal 102 via an interface such as a USB.

As shown in FIG. 1, the kitchen printer 103 has an upper surface as an operation display surface 111. A keyboard 112 and a display 113 are arranged on the operation display surface 111. The kitchen printer 103 incorporates, for example, a thermal printer (not shown) and prints and issues a cooking instruction slip (not shown) for chefs who work in the kitchen. The kitchen printer 103 issues the cooking instruction slip from a slip issue port 114 arranged in the front.

As shown in FIG. 1, the station 105 includes a small liquid crystal display 116 and a keyboard 117 and executes, for example, management of various kinds of information transmitted from the information terminals 102.

In the customer-service supporting system 101 schematically explained above, the information terminals 102, the kitchen printer 103, and the station 105 are connected to freely transmit data to and receive data from one another via a LAN. The information terminals 102 can input guide information for guiding a customer to a table and order information concerning a menu order. The information terminals 102 transmit the input order information to the station 105 through the LAN. The station 105 further transmits the received order information to the kitchen printer 103 through the LAN. The kitchen printer 103 prints and issues a slip having content corresponding to the received order information. As explained above, the slip printed and issued by the kitchen printer 103 is a cooking instruction slip for instructing the chefs in the kitchen about ordered menu items. The information terminal 102 functioning as the POS terminal executes checkout processing.

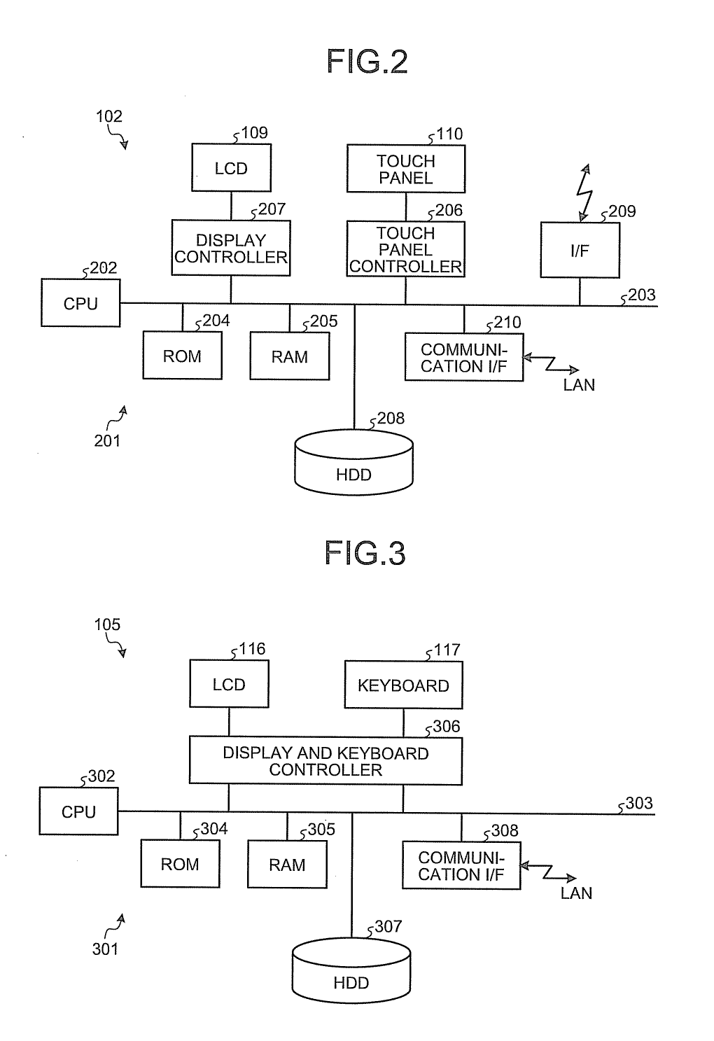

FIG. 2 is a block diagram of electric connection of the information terminal 102. As shown in FIG. 2, the information terminal 102 includes a microcomputer 201. The microcomputer 201 controls to drive the units of the information terminal 102. In the microcomputer 201, a read only memory (ROM) 204 configured to store stationary information such as a control program in advance and a random access memory (RAM) 205 configured to rewritably store various kinds of information and function as a work area and the like are connected, via a bus line 203, to a CPU 202 configured to centrally control the units. Therefore, the microcomputer 201 configures an information processing unit configured to execute information processing.

In the information terminal 102, a touch panel controller 206, a display controller 207, a HDD 208, an interface 209, and a communication interface 210 are connected to the microcomputer 201 via the bus line 203. The touch panel controller 206 captures an input signal from the touch panel 110 into the microcomputer 201. The display controller 207 controls to drive, based on image data, the liquid crystal display 109 and displays the image data on the liquid crystal display 109. The interface 209 is an interface for connecting the printer 106 and the customer-side display device 107 to the microcomputer 201 and is, for example, a USB. The communication interface 210 is an interface for allowing the microcomputer 201 to perform data communication with other apparatuses through the LAN.

In the information terminal 102, an operating system (OS), a computer program, various files, and the like are installed in the HDD 208.

FIG. 3 is a block diagram of electric connection of the station 105. As shown in FIG. 3, the station 105 includes a microcomputer 301. The microcomputer 301 controls to drive the units of the station 105. In the microcomputer 301, a ROM 304 configured to store stationary information such as a control program in advance and a RAM 305 configured to rewritably store various kinds of information and function as a work area and the like are connected, via a bus line 303, to a CPU 302 configured to centrally control the units. Therefore, the microcomputer 301 configures an information processing unit configured to execute information processing.

In the station 105, a display and keyboard controller 306, a HDD 307, and a communication interface 308 are connected to the microcomputer 301 via the bus line 303. The display and keyboard controller 306 controls to drive, based on image data, the liquid crystal display 116 to display the image data on the liquid crystal display 116 and captures an input signal from the keyboard 117 into the microcomputer 301. The communication interface 308 is an interface for allowing the microcomputer 301 to perform data communication with other apparatuses through the LAN.

In the station 105, an OS, a computer program, various files, and the like are installed in the HDD 307.

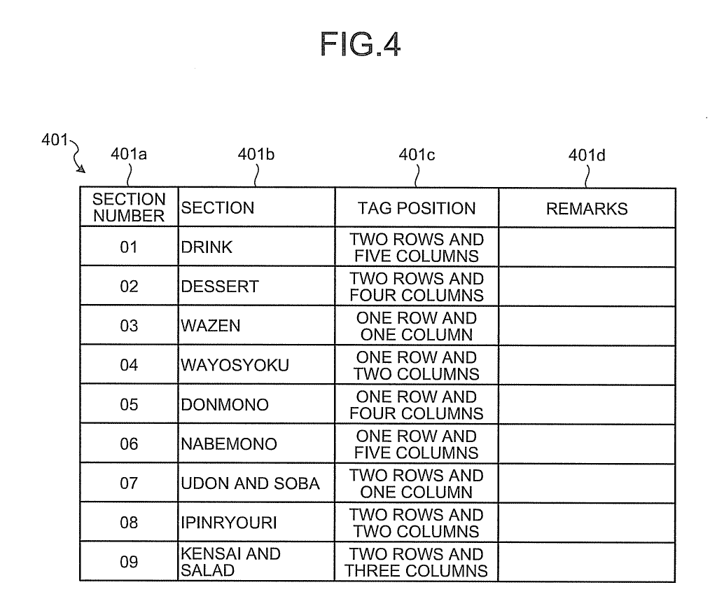

FIG. 4 is a schematic diagram of the file structure of a section file 401 accessible by the information terminal 102 and the station 105. In the information terminal 102 and the station 105, the section file 401 is installed in the HDD 208 of the information terminal 102 and the HDD 307 of the station 105.

In the section file 401, a section 401b, a tag position 401c, and remarks 401d are registered in association with a two-digit section number 401a for specifying a section. As an example, sections are registered in association with the section number 401a as described below.

01: drink

02: dessert

03: wazen

04: wayosyoku

05: donmono

06: nabemono

07: udon and soba

08: ipinryouri

09: kensai and salad

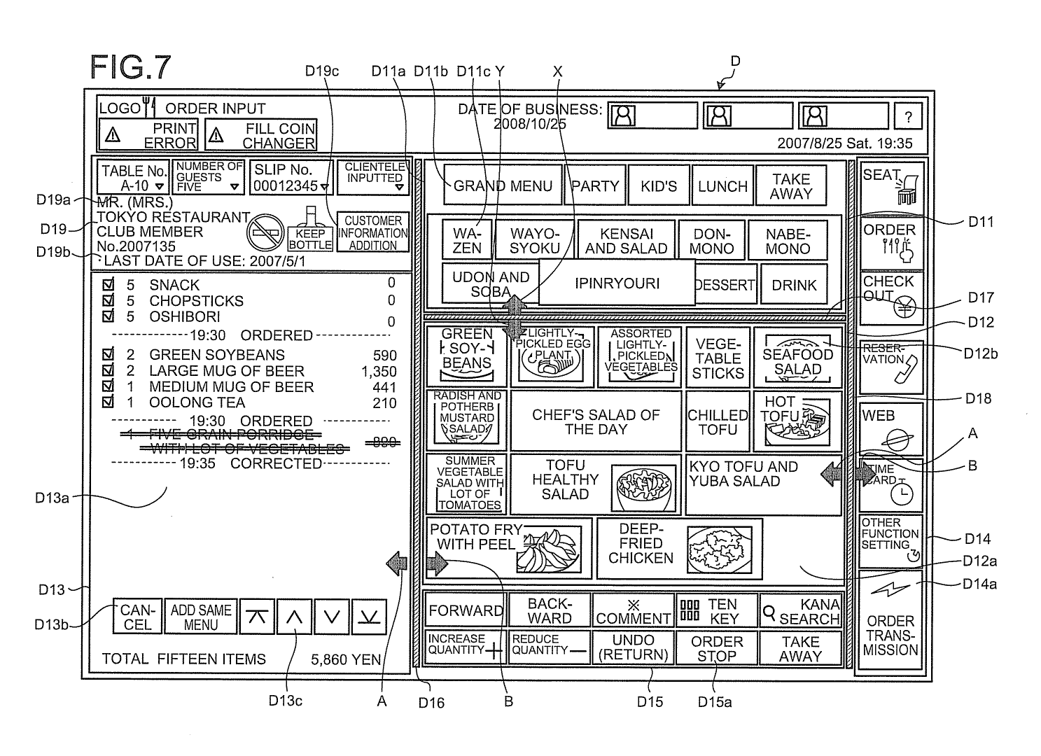

In the section file 401, section names of sections are registered in the section 401b. In the section file 401, the arrangement of main buttons D11b and sub-buttons D11c for displaying the section names in a section tag space D11a (see FIG. 7) is registered in the tag position 401c. In this embodiment, in the section file 401, rows and columns indicating the positions of the main buttons D11b and the sub-buttons D11c are registered in the tag position 401c as the arrangement of the main buttons D11b and the sub-buttons D11c. The remarks 401d is a space in which various kinds of information can be written for, for example, information management.

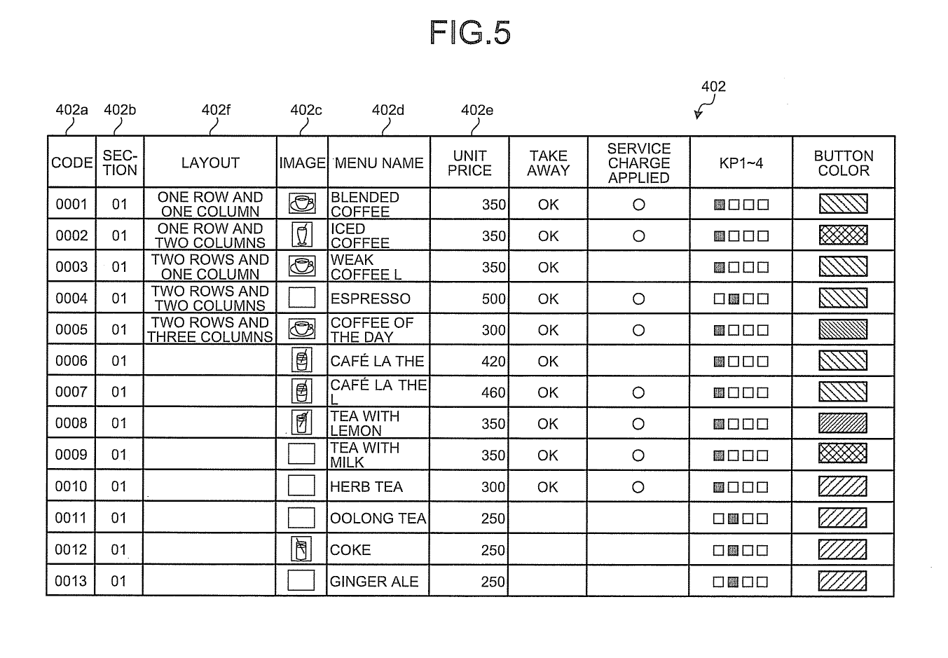

FIG. 5 is a schematic diagram of the file structure of a price look up (PLU) file 402 accessible by the information terminal 102 and the station 105. In the information terminal 102 and the station 105, the PLU file 402 is installed in the HDD 208 of the information terminal 102 and the HDD 307 of the station 105.

In the PLU file 402, a section 402b, an image link 402c, a menu name 402d, a unit price 402e, and a layout 402f are registered in association with a code 402a for specifying a menu item. The section 402b represents the section 401b in the section file 401. The image link 402c defines a link to image data displayed on menu buttons D12b in a menu item space D12a (see FIG. 7). In the information terminal 102 and the station 105, the image data displayed on the menu buttons D12b is installed in the HDD 208 of the information terminal 102 and the HDD 307 of the station 105. In the PLU file 402, item names of menu items are registered in the menu name 402d. Also, in the PLU file 402, unit prices of the menu items are registered in the unit price 402e. Layout positions of the menu buttons D12b in the menu item space D12a (see FIG. 7) for menu items are registered in the layout 402f. In this embodiment, in the PLU file 402, rows and columns of the menu buttons D12b in the menu item space D12a are registered in the layout 402f as layout positions of the menu buttons D12b.

For example, as it is seen with reference to FIGS. 4 and 5, a code “0001” for specifying a menu item defines “blended coffee” of a section “drink” and sets a unit price “¥350”. A code “0002” defines “iced coffee” in the section “drink” and sets a unit price “¥350”.

Characteristic processing of the information terminal 102 according to this embodiment among kinds of processing executed by the microcomputer 201 according to the OS and the computer program installed in the HDD 208 of the information terminal 102 is explained below.

The OS and the computer program executed by the information terminal 102 according to this embodiment may be provided while being recorded in a computer-readable recording medium such as a compact disk-read only memory (CD-ROM), a flexible disk (FD), a compact disk-recordable (CD-R), or a digital versatile disk (DVD) as a file of an installable format or an executable format.

The OS and the computer program executed by the information terminal 102 according to this embodiment may be stored on a computer connected to a network such as the Internet and downloaded through the network. The OS and the computer program executed by the information terminal 102 according to this embodiment may be provided or distributed through the network such as the Internet.

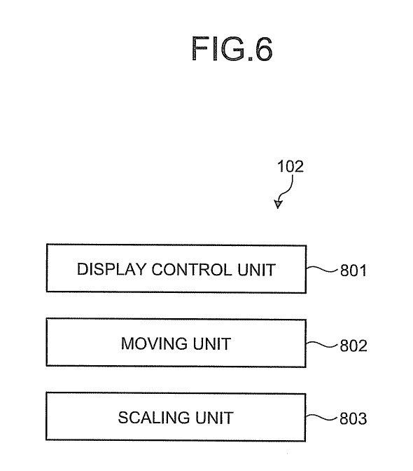

The computer program executed by the information terminal 102 according to this embodiment has a module configuration including units (a display control unit 801, a moving unit 802, and a scaling unit 803) shown in FIG. 6. As actual hardware, the CPU 202 of the microcomputer 201 reads out the computer program from the HDD 208 and executes the computer program, whereby the units are loaded onto the RAM 205 to generate the display control unit 801, the moving unit 802, and the scaling unit 803 on the RAM 205.

As shown in FIG. 7, the display control unit 801 displays, on the liquid crystal display 109, an order input screen D on which function information concerning menu order functions such as the main buttons D11b and the sub-buttons D11c in the section tag space D11a, the menu buttons D12b in the menu item space D12a, an order list D13a, buttons D13b, sign buttons D13c, job designation keys D14a, function keys D15a, customer-information input buttons D19a, a customer information space D19b, and a customer-information adding button D19c is arranged in a plurality of areas D11 to D15 and D19.

The display control unit 801 arranges, in one row and six columns in the section tag space D11a, the main buttons D11b (“grand menu”, etc.) on which section names registered in the section 401b of the section file 401 are displayed. The display control unit 801 arranges, in two rows and five columns in the section tag space D11a arranged in the area D11, the sub-buttons D11c (“wazen”, etc.) on which section names registered in the section 401b in association with the section number 401a of the section file 401 are displayed. The display control unit 801 arranges the main buttons D11b and the sub-buttons D11c as objects that can be touch-designated through the touch panel 110.

The display control unit 801 arranges, in four rows and five columns in the menu item space D12a arranged in an area D12, the menu buttons D12b including image data at link destinations, which are defined by the image link 402c, and the menu name 402d in association with the code 402a of the PLU file 402 in an initial state. The display control unit 801 arranges, like the main buttons D11b and the sub-buttons D11c, the menu buttons D12b as objects that can be touch-designated through the touch panel 110.

The display control unit 801 arranges, in an area D13, the order list D13a including a list of menu items, the number of orders, and an amount (a unit price×the number of orders) touch-designated on the order input screen D through the touch panel 110. The display control unit 801 arranges, in one row and two columns in the area D13, the buttons D13b (“cancel”, “add the same menu”, etc.) for executing cancellation, addition, and the like of the menu items included in the order list D13a. Further, the display control unit 801 arranges, in one row and four columns in the area D13, the sign buttons D13c (“̂”, etc.) for executing, for example, movement of a highlight indicating a target menu item of cancellation, addition, or the like among the menu items included in the order list D13a.

The display control unit 801 arranges, in eight rows and one column in an area D14, as objects that can be touch-designated through the touch panel 110, job designation keys D14a (“checkout”, “order transmission”, etc.) for designating execution of various jobs such as execution of checkout processing and execution of order transmission.

The display control unit 801 arranges, in two rows and five columns in an area D15, as objects that can be touch-designated through the touch panel 110, the function keys D15a (“quantity increase”, “quantity decrease”, etc.) for designating execution of various functions such as execution of processing for increasing the number of orders and execution of processing for reducing the number of orders.

The display control unit 801 arranges, in one row and four columns in an area D19, as objects that can be touch-designated through the touch panel 110, the customer-information input buttons D19a (“table No.”, “number of guests”, “slip”, “clientele”, etc.) for inputting customer information of a customer whose order is received. The display control unit 801 arranges, in the area D19, the customer information space D19b (“Tokyo restaurant club member”, etc.) input by the customer-information input buttons D19a. Further, the display control unit 801 arranges, in the area D19, as an object that can be touch-designated through the touch panel 110, for example, the customer-information adding button D19c for adding customer information.

The display control unit 801 displays, at aspect ratios set in advance, frames of the buttons and the keys arranged in the areas in the order input screen D and images and figures in the buttons. The display control unit 801 arranges, according to the number of rows and the number of columns set in advance for each of the areas, the buttons and the keys arranged in the areas in the order input screen D.

On the order input screen D, in inputting a menu item, a user can select a desired section out of “drink”, “dessert”, “wazen”, “wayosyoku”, “donmono”, “nabemono”, “udon and soba”, “ipinryouri”, and “kensai and salad” by touch-designating (clicking) a desired sub-button D11c. For example, when the user touch-designates (clicks) the sub-button D11c of “ipinryouri” among the sub-buttons D11c, the display control unit 801 displays the order input screen D concerning “ipinryouri” illustrated in FIG. 7.

As shown in FIG. 7, the display control unit 801 displays, on the liquid crystal display 109, the order input screen D in which slide bars D16 to D18 as designation lines for designating moving positions of boundaries are arranged on a boundary between the area D13 and the areas D11 and D12, a boundary between the area D11 and the area D12, and a boundary between the areas D11, D12, and D15 and the area D14. The display control unit 801 displays the slide bars D16 to D18 as objects that can be touch-designated through the touch panel 110.

The user moves (drags) the slide bars D16 to D18 in directions A and B or directions X and Y while keeping the slide bars D16 to D18, which are displayed on the boundaries for designating the moving positions, touch-designated and releases the touch designation (drops the slide bars D16 to D18) in a state in which the slide bars D16 to D18 are moved to desired moving positions. Consequently, the user can designate, as moving positions, positions where the slide bars D16 to D18 are dropped.

For example, when the user touch-designates the main button D11b and the sub-button D11c arranged in the section tag space D11a to select a section of a menu item to be ordered, the user moves the slide bar D17 in the direction Y while keeping on touch-designating the slide bar D17 and releases the touch designation in a state in which the slide bar D17 is moved to a desired moving position.

When the user touch-designates the menu button D12b arranged in the menu item space D12a to select a menu item to be ordered, the user moves the slide bar D17 in the direction X while keeping on touch-designating the slide bar, D17 and releases the touch designation in a state in which the slide bar D17 is moved to a desired moving position.

When the user touch-designates the main button D11b and the sub-button D11c arranged in the section tag space D11a to select a section of a menu item to be ordered or when the user touch-designates the menu button D12b arranged in the menu item space D12a to select a menu item to be ordered, the user moves the slide bar D16 in the direction A while keeping on touch-designating the slide bar D16 and releases the touch designation in a state in which the slide bar D16 is moved to a desired moving position. When the user touch-designates the main button D11b and the sub-button D11c arranged in the section tag space D11a to select a section of a menu item to be ordered or when the user touch-designates the menu button D12b arranged in the menu item space D12a to select a menu item to be ordered, the user may move the slide bar D18 in the direction B while keeping on touch-designating the slide bar D18 and release the touch designation in a state in which the slide bar D18 is moved to a desired moving position.

When the user performs cancellation or addition of a menu item included in the order list D13a or touch-designates the customer-information input buttons D19a to input customer information, the user moves the slide bar D16 in the direction B while keeping on touch-designating the slide bar D16 and releases the touch designation in a state in which the slide bar D16 is moved to a desired moving position.

When the user designates execution of various jobs using the job designation keys D14a, the user moves the slide bar D18 in the direction A while keeping on touch-designating the slide bar D18 and releases the touch designation in a state in which the slide bar D18 is moved to a desired moving position.

In this embodiment, the order input screen D in which the slide bars D16 to D18 are arranged is displayed on the liquid crystal display 109. However, any image may be displayed as long as moving positions of the boundaries can be designated.

Further, the display control unit 801 displays a slide bar displayed on a moving boundary among the slide bars D16, D17, and D18 as a special image (e.g., a bold line or a yellow line) different from the display (e.g., a thin line or gray-out) of the other slide bars.

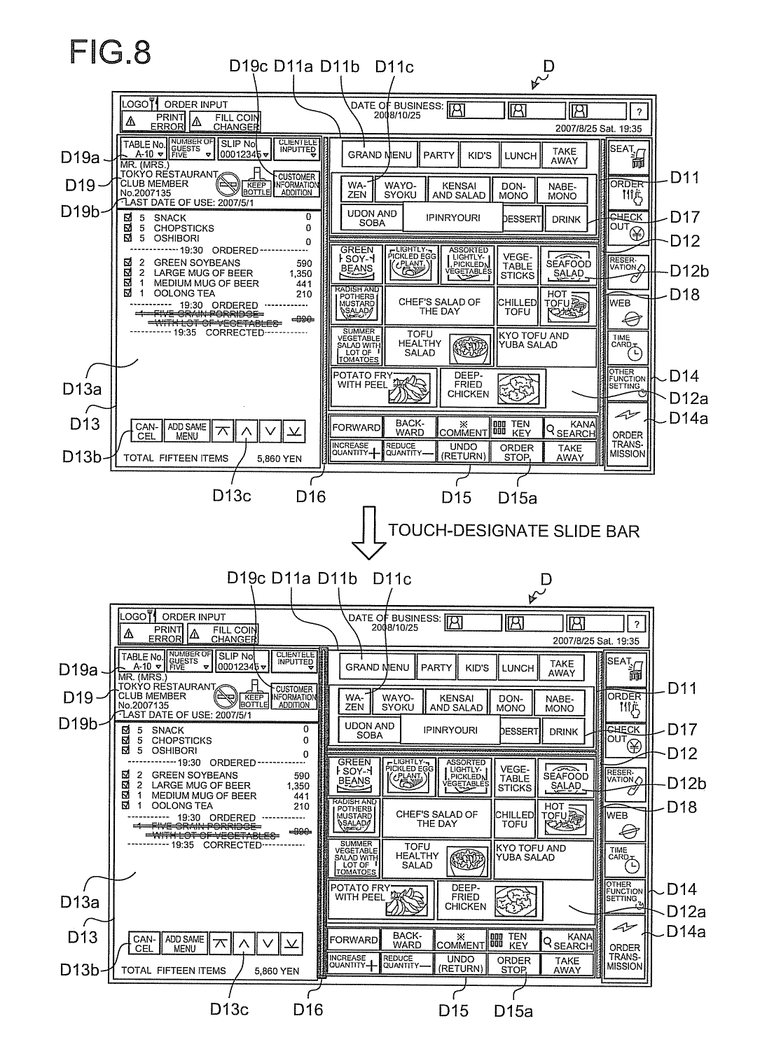

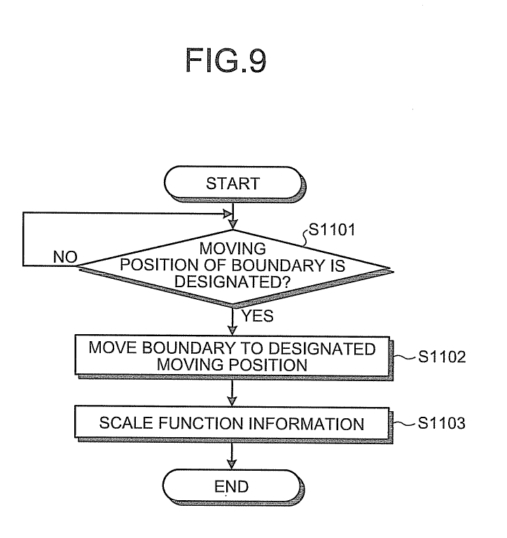

FIG. 8 is an illustrative front view of the order input screen including the slide bar displayed as the special image. As shown in FIG. 8, when the slide bar D16 displayed on a moving boundary is touch-designated, the display control unit 801 changes the display of the slide bar D16 from the thin line to the bold line.

The information terminal 102 according to this embodiment has a moving mode for allowing designation of a moving position and a fixed mode for disallowing designation of a moving position by the operation of the slide bars D16, D17, and D18. When the slide bar D16, D17, or D18 is clicked, the display control unit 801 shifts the information terminal 102 from the fixed mode to the moving mode. Therefore, the display control unit 801 displays the slide bar D16, D17, or D18 as a special image according to touch designation of the slide bar D16, D17, or D18 while the information terminal 102 is shifted to the moving mode. When the user touches the slide bar D16, D17, or D18 without intending to operate the slide bar D16, D17, or D18, malfunction such as designation of a moving position or a change in a layout of the order input screen D is prevented from occurring.

The user may perform mode switching using a switching button (not shown) for switching the moving mode for allowing designation of a moving position and the fixed mode for disallowing designation of a moving position.

Layout change processing for the order input screen D explained above is explained below. FIG. 9 is a flowchart for explaining a flow of the layout change processing. As shown in FIG. 9, the moving unit 802 stays on standby until the information terminal 102 is switched to the moving mode, any one of the slide bars D16 to D18 is drag-and-dropped, and a moving position of the boundary is designated (No in Act 1101). If the moving unit 802 determines that any one of the slide bars D16 to D18 is drag-and-dropped and a moving position of the boundary is designated (Yes in Act 1101), the moving unit 802 moves the drag-and-dropped boundary (the boundary between the areas adjacent to each other) to the designated moving position (Act 1102). For example, when a moving position shifted in the direction B from the position of the slide bar D16 shown in FIG. 7 is designated, the moving unit 802 expands the areas D13 and D19, which are adjacent to each other along the boundary on which the slide bar D16 is arranged, in the direction B and reduces the areas D11, D12, and D15 in the direction B to thereby move the boundary between the areas D13 and D19 and the areas D11, D12, and D15 to the moving position.

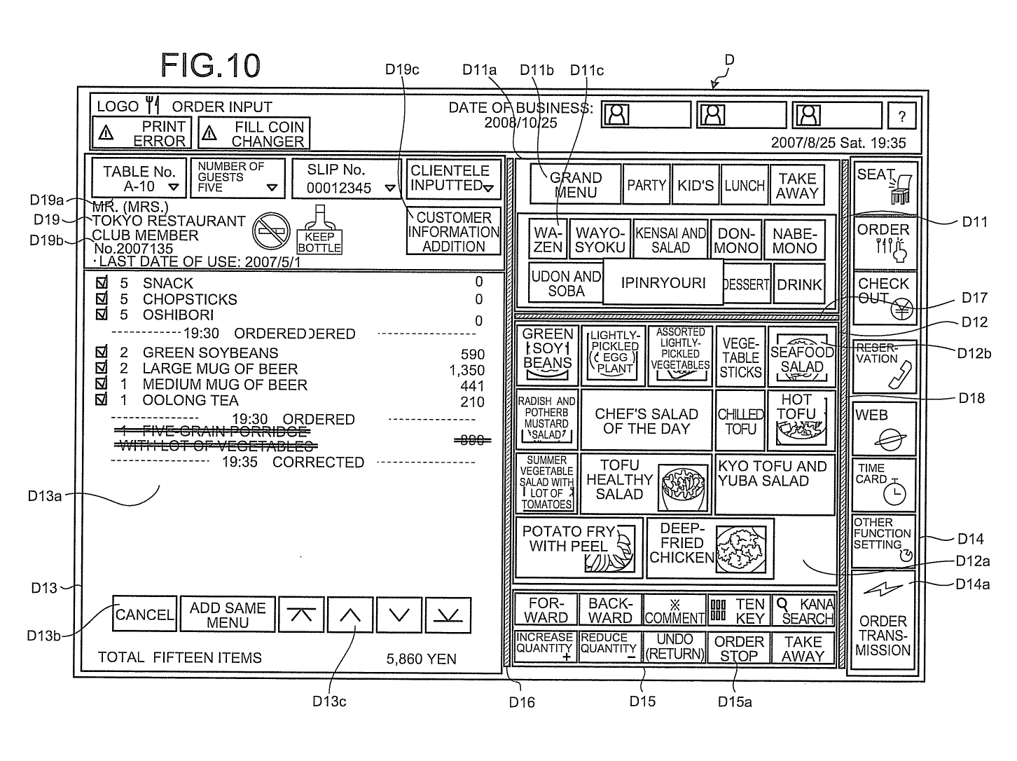

The scaling unit 803 scales function information arranged in the areas adjacent to each other across the boundary moved by the moving unit 802 (Act 1103). FIG. 10 is an illustrative diagram of the order input screen. When the boundary between the areas 13 and D19 and the areas D11, D12, and D15 in the order input screen D shown in FIG. 7 moves in the direction B, the scaling unit 803 expands the order list D13a, the buttons D13b, the sign buttons D13c, the customer-information input button D19a, the customer information space D19b, and the customer-information adding button D19c arranged in the areas D13 and D19 and reduces the main buttons D11b, the sub-buttons D11c, the menu buttons D12b, and the function keys D15a arranged in the areas D11, D12, and D15. More specifically, the scaling unit 803 calculates a scaling ratio for scaling frames of the buttons D13b, the sign buttons D13c, the customer-information input buttons D19a, and the customer-information adding buttons D19c and images and figures in the buttons according to the sizes of the areas D13 and D19 demarcated by the moved boundary and while maintaining aspect ratios set in advance. The scaling unit 803 expands, according to the calculated scaling ratio, the frames of the buttons D13b, the sign buttons D13c, the customer-information input buttons D19a, and the customer-information adding buttons D19c and the images and the figures in the buttons. The scaling unit 803 calculates a scaling ratio for scaling, according to the size of the area D13 demarcated by the moved boundary, a space between menu names (e.g., “green soybeans” and “large mug of beer”) and a total number of items (e.g., fifteen items) on the left side and amounts of the items (e.g., “590” and “1,350”) and a total amount (e.g., ¥5,860) on the right side included in the order list D13a. The scaling unit 803 expands, according to the calculated scaling ratio, the space between the menu names (e.g., “green soybeans” and “large mug of beer”) and the total number of items (e.g., fifteen items) on the left side and the amounts of the items (e.g., “590” and “1,350”) and the total amount (e.g., ¥5,860) on the right side included in the order list D13a. The scaling unit 803 calculates, according to the size of the area D19 demarcated by the moved boundary, a space between the customer information space D19b (e.g., “Tokyo restaurant club member”) and the customer-information adding button D19c. The scaling unit 803 expands, according to the calculated scaling ratio, the space between the customer information space D19b (e.g., “Tokyo restaurant club member”) and the customer-information adding button D19c. The scaling unit 803 calculates a scaling ratio for scaling frames of the main buttons D11b, the sub-buttons D11c, the menu buttons D12b, and the function keys D15a and images and figures in the buttons and the keys according to the sizes of the areas D11, D12, and D15 demarcated by the moved boundary and while maintaining aspect ratios set in advance. The scaling unit 803 reduces, according to the calculated scaling ratio, the frames of the main buttons D11b, the sub-buttons D11c, the menu buttons D12b, and the function keys D15a and the images and the figures in the buttons and the keys.

In this embodiment, the scaling unit 803 scales the buttons and the keys arranged in the areas in the order input screen D while keeping the number of rows and the number of columns set in advance for each of the areas. For example, when the scaling unit 803 scales the menu buttons D12b arranged in the menu item space D12a of the area D12, the scaling unit 803 scales the menu buttons D12b while keeping the number of rows and the number of columns set in advance (four rows and five columns).

In this embodiment, when the scaling unit 803 scales the order list D13a and the customer information space D19b, for example, the scaling unit 803 scales a space between the menu names and the amounts of the menu items included in the order list D13a. However, the scaling unit 803 may scale the order list D13a and the customer information space D19b by deleting information with low importance (e.g., the menu names and the number of orders) from the information (the menu names, the number of orders, the amounts, etc.) included in the order list D13a and the customer information space D19b.

In this embodiment, when the scaling unit 803 scales the function information such as the main buttons D11b, the sub-buttons D11c, the menu buttons D12b, the order list D13a, the buttons D13b, the sign buttons D13c, the jog designation keys D14a, the function keys D15a, the customer-information input buttons D19a, the customer information space D19b, and the customer-information adding buttons D19c, the scaling unit 803 does not change fonts of characters displayed in the function information.

When a not-shown initial screen button arranged in the order input screen D is touch-designated, the scaling unit 803 resets the function information arranged in the areas D11, D12, D13, D14, D15, and D19 of the order input screen D to sizes before the scaling (shown in FIG. 7).

According to this embodiment, by operating the slide bars D16, D17 and D18, the user can freely change, according to a scene of use of the information terminal 102, a layout of information concerning menu order functions such as the menu buttons D12b and the order list D13a to a layout that the user desires to use. Therefore, it is possible to provide the order input screen D with high convenience, a layout of which the user can correct visually, interactively, and intuitively.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. An order receiving apparatus comprising:
a display control unit configured to display an order input screen in which function information concerning menu order functions is arranged in a plurality of areas;
a moving unit configured to move a boundary between the areas adjacent to each other; and
a scaling unit configured to scale the function information arranged in the areas adjacent to each other across the moved boundary.

2. The apparatus according to claim 1, wherein
the display control unit displays, on the boundary between the areas adjacent to each other, a designation line for designating a moving position of the boundary, and
the moving unit moves the boundary between the areas adjacent to each other to the moving position designated by the designation line.

3. The apparatus according to claim 2, wherein the display control unit displays, as a special image different from other designation lines, the designation line displayed on the boundary moved by the moving unit.

4. The apparatus according to claim 1, wherein
the apparatus has a moving mode for allowing the movement of the boundary between the areas adjacent to each other and a fixed mode for disallowing the movement of the boundary between the areas adjacent to each other, and
the moving unit moves the boundary of the areas adjacent to each other only during the moving mode.

5. The apparatus according to claim 1, wherein
the display control unit displays the order input screen in which buttons and keys are arranged in the areas as the function information, and
the scaling unit scales the buttons and the keys while maintaining aspect ratios of the buttons and the keys.

6. An order receiving method comprising:
displaying an order input screen in which function information concerning menu order functions is arranged in a plurality of areas;
moving a boundary between the areas adjacent to each other; and
scaling the function information arranged in the areas adjacent to each other across the moved boundary.

7. The method according to claim 6, further comprising:
displaying, on the boundary between the areas adjacent to each other, a designation line for designating a moving position of the boundary; and
moving the boundary between the areas adjacent to each other to the moving position designated by the designation line.

8. The method according to claim 7, further comprising displaying, as a special image different from other designation lines, the designation line displayed on the moved boundary.

9. The method according to claim 6, wherein
the method has a moving mode for allowing the movement of the boundary between the areas adjacent to each other and a fixed mode for disallowing the movement of the boundary between the areas adjacent to each other, and
the method further comprising moving the boundary of the areas adjacent to each other only during the moving mode.

10. The method according to claim 6, further comprising:
displaying the order input screen in which buttons and keys are arranged in the areas as the function information, and
scaling the buttons and the keys while maintaining aspect ratios of the buttons and the keys.
